(19) United States
(12) Patent Application Publication
(10) Pub. No.: US 2014/0278540 A1
(43) Pub. Date: Sep. 18, 2014

(54) INFORMATION PROCESSING APPARATUS, INFORMATION PROCESSING METHOD, AND PROGRAM

(71) Applicant: SONY CORPORATION, Tokyo (JP)

(72) Inventors: Hiroshi KYUSOJIN, Tokyo (JP); Kenji YAMANE, Kanagawa (JP); Yutaka HASEGAWA, Kanagawa (JP); Hirofumi WATANABE, Saitama (JP)

(73) Assignee: SONY CORPORATION, Tokyo (JP)

(21) Appl. No.: 14/194,990

(22) Filed: Mar. 3, 2014

(30) Foreign Application Priority Data
Mar. 14, 2013 (JP) 2013-052183

(51) Int. Cl. G06F 19/00

(52) U.S. Cl. CPC G06F 19/321
USPC 705/3

(57) ABSTRACT

An information processing apparatus includes a storage unit, a communication unit, and a control unit. The storage unit stores pathological image data items associated with patient information, and correspondence relationship information that indicates a correspondence relationship between a first different information processing apparatus accessible to the patient information, and a second different information processing apparatus accessible to the pathological image data items and inaccessible to the patient information. The control unit is capable of controlling the communication unit to receive, from the first different information processing apparatus, a first display request of a first pathological image data item searched for based on predetermined patient information, and generating, based on the correspondence relationship information, a first virtual folder including the first pathological image data item that is accessible by the second different information processing apparatus that corresponds to the first different information processing apparatus that sends the first display request.

### CROSS REFERENCES TO RELATED APPLICATIONS

The present application claims priority to Japanese Priority Patent Application JP 2013-052183 filed in the Japan Patent Office on Mar. 14, 2013, the entire content of which is hereby incorporated by reference.

### BACKGROUND

The present disclosure relates to an information processing apparatus that is capable of performing information processing for display of a digital pathological image with a different information processing apparatus, to an information processing method for the information processing apparatus, and to a program therefor.

From the past, in a network system that manages medical information in a hospital or the like, a laboratory information system (LIS) server and a picture archiving and communication systems (PACS) are used. The LIS server stores and manages examination information including attribute information of patients such as a patient name and age. The PACS server stores and manages image data (X-ray image data and pathological image data) captured with a diagnosis target site of a patient being a subject.

For example, in the above-mentioned network system, a case where a user (doctor) operates a client terminal to display a pathological image stored in the PACS server is assumed. First, the user accesses the LIS server using patient information such as a patient name (patient number), data and time of examination, and a disease name, and obtains examination information. This examination information describes what identifier (file name) the captured pathological image is stored with. The client terminal obtains the pathological image from the PACS server using the obtained identifier and displays the pathological image on a display. Japanese Patent Application Laid-open No. 2000-316816 (hereinafter, referred to as Patent Document 1) also describes a similar system.

### SUMMARY

In this manner, in the traditional system as described in the Patent Document 1, a function of performing a search of the PACS server as well as a main function of displaying data obtained from the PACS server are necessary for a PACS client terminal (image display apparatus in Patent Document 1). In such an approach, for example, every time when a PACS server that stores medical image data, which is of a different type from that of the traditional PACS server, is newly added to a hospital system, a new client terminal that accesses examination information corresponding to such image data becomes necessary.

However, the LIS server includes personal information for identifying a patient, and hence an increase of the number of client terminals that access the LIS server may increase the possibility of information leakage, which is not favorable.

In view of the above-mentioned circumstances, it is desirable to provide an information processing apparatus that enables, without increasing the number of terminals accessible to personal information of patients, clinical image data of a pathological image or the like that is searched for using patient information to be displayed in another terminal as if the clinical image data was a search result of the other terminal, an information processing method, and a program.

According to an embodiment of the present disclosure, there is provided an information processing apparatus including a storage unit, a communication unit, and a control unit. The storage unit is configured to store a plurality of pathological image data items associated with patient information, and correspondence relationship information that indicates a correspondence relationship between a first different information processing apparatus configured to be accessible to the patient information, and a second different information processing apparatus configured to be accessible to the plurality of pathological image data items and inaccessible to the patient information. The control unit is configured to be capable of controlling the communication unit to receive, from the first different information processing apparatus, a first display request of a first pathological image data item searched for based on predetermined patient information. Further, the control unit is configured to be capable of generating, based on the correspondence relationship information, a first virtual folder including the first pathological image data item, the first virtual folder being accessible by the second different information processing apparatus that corresponds to the first different information processing apparatus that sends the first display request.

With this configuration, the apparatus accessible to the patient information is divided from and associated with the apparatus accessible to the pathological image data item, and hence the information processing apparatus is capable of generating the virtual folder including the pathological image data item as the search result. Thus, the information processing apparatus enables, without increasing the number of terminals accessible to personal information of patients, clinical image data of a pathological image or the like that is searched for using patient information to be displayed in another terminal (second different information processing apparatus) as if the clinical image data was a search result of the other terminal.

The control unit may be configured to control the communication unit to send an open request for requesting to open the first virtual folder to the second different information processing apparatus.

With this, the information processing apparatus enables the second different information processing apparatus to display the pathological image data item of the search result without forcing the user of the second different information processing apparatus to perform an operation of opening a folder.

The control unit may be configured to control the communication unit to send an open and display request for requesting to open the first virtual folder and display a predetermined pathological image data item to the second different information processing apparatus.

With this, for example, in the case where a plurality of first pathological image data items are present in the virtual folder, the information processing apparatus enables the second different information processing apparatus to display the pathological image data item of the search result without forcing the user of the second different information processing apparatus to perform an operation of opening a folder and selecting a particular pathological image data item.

The control unit may be configured to control, after receiving the first display request, the communication unit to receive a second display request of a second pathological image data item searched for based on predetermined patient information from the first different information processing apparatus. Further, the control unit may be configured to generate a second virtual folder including the second pathological image data item in the same hierarchy layer as the first virtual folder, the second virtual folder being accessible only by the second different information processing apparatus.

With this, when a search based on the patient information is successively performed, the information processing apparatus enables the second different information processing apparatus to display the virtual folder on the same user interface as the virtual folder as the previous search result.

The first virtual folder and the second virtual folder may respectively include a plurality of first pathological image data items and a plurality of second pathological image data items. In this case, the control unit may be configured to enable the second different information processing apparatus to selectively display a first screen in which a virtual folder is displayed, and a second screen in which one pathological image data item in the virtual folder is displayed together with a thumbnail list of all pathological image data items in the virtual folder. Further, the control unit may be configured to control the second different information processing apparatus to display, when the second display request is received in a state where the second screen is displayed in the second different information processing apparatus, the second pathological image data item and a second thumbnail list that correspond to the second virtual folder instead of the first pathological image data item and a first thumbnail list that correspond to the first virtual folder.

With this, every time when a display request based on a new search result is sent from the first different information processing apparatus, the information processing apparatus enables the second different information processing apparatus to replace the pathological image data item and the thumbnail list by data of another virtual folder and display the data.

Further, the control unit may be configured to control the second different information processing apparatus to display, when operation notification information for notifying of a predetermined operation input is received from the second different information processing apparatus in a state where the second screen is displayed in the second different information processing apparatus, an image for notifying of a movement from the first virtual folder to the second virtual folder, and to display the second pathological image data item and a second thumbnail list that correspond to the second virtual folder instead of the first pathological image data item and a first thumbnail list that correspond to the first virtual folder.

With this, based on a predetermined operation from the second different information processing apparatus, the information processing apparatus enables a movement between the virtual folders in the same hierarchy layer to be performed without needing an operation of moving to a virtual folder in an upper layer thereof, such that the image data item of the virtual folder after the movement can be automatically displayed.

The control unit may be configured to control, after receiving the first display request, the communication unit to receive a delete request of the first pathological image data item from the first different information processing apparatus, delete the first virtual folder based on the delete request, and control the communication unit to send notification information for informing of the deletion to the second different information processing apparatus.

With this, the information processing apparatus can delete the virtual folder based on the delete request sent from the first different information processing apparatus, and inform the user of the second different information processing apparatus of the deletion.

The control unit may be configured to control, when the first virtual folder is opened, the communication unit to receive, from the first different information processing apparatus, a delete request of the first pathological image data item, delete the first virtual folder based on the delete request, and control the communication unit to send an open request for requesting to open the second virtual folder to the second different information processing apparatus.

With this, when the first virtual folder is deleted based on a request sent from the first different information processing apparatus, the information processing apparatus enables the second different information processing apparatus to automatically open the remaining second virtual folder to display the second pathological image data item.

The control unit may be configured to control the communication unit to receive a third display request of a third pathological image data item that matches a predetermined search condition from the second different information processing apparatus, and generate, based on the third display request, a third virtual folder including a third pathological image data item in the same hierarchy layer as the first virtual folder.

With this, the information processing apparatus enables the folder searched from based on the request sent from the second different information processing apparatus to be also accessible on the same user interface as the folder searched for based on the request sent from the first different information processing apparatus.

According to another embodiment of the present disclosure, there is provided an information processing method including receiving, from a first different information processing apparatus configured to be accessible to patient information, a display request of a pathological image data item searched for based on predetermined patient information, identifying a second different information processing apparatus configured to be accessible to the pathological image data item and inaccessible to the patient information, the second different information processing apparatus being associated with the first different information processing apparatus that sends the display request, and generating a virtual folder including the pathological image data item, the virtual folder being accessible by the second different information processing apparatus.

According to still another embodiment of the present disclosure, there is provided a program that causes an information processing apparatus to execute a reception step, an identification step, and a generation step. In the reception step, a display request of a pathological image data item searched for based on predetermined patient information is received from a first different information processing apparatus configured to be accessible to patient information. In the identification step, a second different information processing apparatus configured to be accessible to the pathological image data item and inaccessible to the patient information is identified, the second different information processing apparatus being associated with the first different information processing apparatus that sends the display request. In the generation step, a virtual folder including the pathological image data item is generated, the virtual folder being accessible by the second different information processing apparatus.

As described above, according to the embodiments of the present disclosure, it is possible to provide an information processing apparatus that enables, without increasing the number of terminals accessible to personal information of patients, clinical image data of a pathological image or the like that is searched for using patient information to be displayed in another terminal as if the clinical image data was a search result of the other terminal.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a view showing a configuration of a digital pathological slide display system according to an embodiment of the present disclosure;

FIG. 2 is a block diagram showing a configuration of hardware of a PACS server in the system;

FIG. 3 is a view showing a folder structure of pathological image data stored in the PACS server;

FIG. 4 is a view showing an example of a table showing a correspondence between client terminals that is stored in the PACS server;

FIG. 5 is a view showing an outer appearance of a controller used for an operation of a PACS client terminal;

FIG. 6 is a flowchart showing a flow of operations of the digital pathological slide display system according to the embodiment of the present disclosure;

FIG. 7 is a view showing an example of a folder view screen displayed in the PACS client terminal;

FIG. 8 is a view showing a folder structure in the PACS server when a display request of a search result is sent from a LIS client terminal;

FIG. 9 is a view showing an example of a slide view screen displayed in the PACS client terminal when the display request of the search result is sent from the LIS client terminal;

FIG. 10 is a view showing an example of the folder view screen displayed in the PACS client terminal when the display request of the search result is sent from the LIS client terminal;

FIG. 11 is a view showing the folder structure in the PACS server when a display request of a further search result is sent from the LIS client terminal;

FIG. 12 is a view showing an example of the slide view screen displayed in the PACS client terminal when the display request of the further search result is sent from the LIS client terminal;

FIG. 13 is a view showing an example of the folder view screen displayed in the PACS client terminal when the further display request of the search result is sent from the LIS client terminal;

FIG. 14 is a view showing a folder structure in the PACS server when a delete request of the search result is sent from the LIS client terminal;

FIG. 15 is a view showing an example of the folder view screen displayed in the PACS client terminal when the delete request of the search result is sent from the LIS client terminal;

FIG. 16 is a view showing a configuration of a folder that can be generated by the PACS server according to a search request of the PACS client terminal;

FIG. 17 is a view showing an example of the folder view screen displayed in the PACS client terminal when the search request is sent from the PACS client terminal;

FIG. 18 is a view showing a display example when a display slide moves to a brother folder on the slide view screen; and

FIG. 19 is a flowchart showing a flow of operations of a digital pathological slide display system according to another embodiment of the present disclosure.

### DETAILED DESCRIPTION

Hereinafter, an embodiment of the present disclosure will be described with reference to the drawings.

[Network Configuration of System]

FIG. 1 is a view showing a network configuration of a digital pathological slide display system according to this embodiment.

As shown in the figure, this system is configured as a network in a hospital, for example. The system includes a PACS server 100, a LIS server 200, a LIS client terminal 400, a PACS client terminal 300, and a LIS client terminal. In the figure, the single PACS client terminal 300 and the single LIS client terminal 400 are shown. However, a plurality of PACS client terminals 300 and a plurality of LIS client terminals 400 may be present.

The PACS server 100 stores and manages slide image data (pathological image data) captured with a diagnosis target site of a patient being a subject. The PACS server 100 displays the pathological image data in the PACS client terminal 300.

The LIS server 200 stores and manages patient information such as a patient name, a patient number, date and time of examination, age and sex of a patient, and a disease name and examination data such as an identifier (file name) of the pathological image data. The LIS server 200 sends back a search result according to a search request sent from the LIS client terminal 400. Only the LIS client terminal 400 is permitted to access the LIS server 200. The PACS client terminal 300 is not permitted to access the LIS server 200.

The PACS client terminal 300 is capable of receiving the pathological image data from the PACS server 100 and displaying the pathological image data due to software adapted for the PACS. In particular, in this embodiment, the PACS client terminal 300 includes a highly sophisticated graphics chip or the like and functions as a high-speed viewer dedicated to huge pathological images.

Due to software adapted for the LIS, the LIS client terminal 400 is capable of accessing the LIS server 200 using patient information, searching for examination information, and obtaining a search result thereof (identifier of pathological image data).

The PACS client terminal 300 and the LIS client terminal 400 are typically present at near positions (e.g., next to each other) and operated by the same user. However, the PACS client terminal 300 and the LIS client terminal 400 may be present at distant positions and operated by different users. That is, the user who searches for a slide may be different from the user who views the slide that matches a search condition.

[Hardware Configuration of PACS Server]

FIG. 2 is a block diagram showing a configuration of hardware of the PACS server 100.

The PACS server 100 includes a central processing unit (CPU) 11, a read only memory (ROM) 12, a random access memory (RAM) 13, an input/output interface 15, and a bus 14 that connects them to one another.

A display unit 16, an input unit 17, a storage unit 18, a communication unit 19, a drive unit 20, and the like are connected to the input/output interface 15.

That is, the PACS server 100 has the same configuration as that of a generally used personal computer (PC).

The display unit 16 is a display device using, for example, a liquid crystal or an electro-luminescence (EL).

The input unit 17 is, for example, a pointing device, a keyboard, a touch panel, a microphone, or another operation apparatus. In the case where the input unit 17 includes a touch panel, the touch panel may be integral with the display unit 16.

The storage unit 18 is a non-volatile storage device. The storage unit 18 is, for example, a hard disk drive (HDD), a flash memory, or another solid-state memory. An application program to be executed for displaying a slide image in the PACS client terminal 300 in this system is also stored in the storage unit 18 in addition to the slide image data. Further, although will be described later, a table showing a correspondence between the PACS client terminal 300 and the LIS client terminal is also stored in the storage unit 18.

The drive unit 20 is, for example, a device capable of driving a removable recording medium 21 such as an optical recording medium, a floppy disk, a magnetic recording tape, and a flash memory. In contrast, the storage unit 18 is often used as a device installed into the PACS server 100 in advance, which mainly drives a non-removable recording medium.

The communication unit 19 is a modem, a router, or another communication apparatus for communicating with a different device such as the PACS client terminal 300, which is connectable to a local area network (LAN), a wide area network (WAN), or the like. The communication unit 19 may perform a wired communication or a wireless communication.

Although not shown in the figure, hardware configurations of the LIS server 200, the PACS client terminal 300, and the LIS client terminal 400 are basically similar to the hardware configuration of the PACS server 100, and includes blocks necessary for functioning as a computer, such as the control unit, the storage unit, and the communication unit.

It should be noted that, as described above, the PACS client terminal 300 includes a highly sophisticated graphics chip for functioning as a high-speed viewer. For example, the PACS client terminal 300 may be a PlayStation (registered trademark) that is a game console manufactured by Sony Computer Entertainment, inc.

Further, the above-mentioned client terminals and servers are shown as stationary apparatuses in FIG. 1. As long as software regarding the above-mentioned LIS or PACS can be executed, the client terminals and servers may be, for example, portable apparatuses such as a smart phone, a cellular phone, a tablet PC, and a laptop PC. That is, the above-mentioned client terminal and servers can be any types of information processing apparatuses.

[Folder Structure within PACS Server]

Next, the folder structure of the slide image data stored in the storage unit 18 of the above-mentioned PACS server 100 will be described. FIG. 3 is a view showing the folder structure.

As shown in the figure, for example, four folders and seven slide images are stored in the storage unit 18. A folder dir1, a folder dir2, and a slide 01 are stored in a layer just below a folder dir0. Three slide images of a slide 10, a slide 11, and a slide 12 are stored in the folder dir1. Under the folder dir2, a folder dir3 and two slides of a slide 20 and a slide 21 are stored. A slide 30 is stored in the folder dir3.

The PACS client terminal 300 is accessible to those folders and slide images.

[Correspondence Relationship Between Client Terminals]

Next, a correspondence between the LIS client terminal 400 and the PACS client terminal 300 will be described.

A table showing the correspondence is stored in the storage unit 18 of the PACS server 100. FIG. 4 is a view showing an example of the table.

As shown in the figure, in the table, an ID of the LIS client terminal 400 as a call source of the pathological image and an ID of the PACS client terminal 300 as a call destination of the pathological image are stored in association with each other.

The ID may be a media access control (MAC) address. A packet of the display request transmitted by the LIS client terminal 400 includes the MAC address. Therefore, the PACS server 100 is capable of identifying the corresponding PACS client terminal 300 based on the MAC address.

Further, the ID may be a universally unique identifier (UUID). By the LIS client terminal 400 involving its own UUID in the packet of the display request, the PACS server 100 is capable of identifying the corresponding PACS client terminal 300.

[Controller of PACS Client Terminal]

Next, a controller for operating the PACS client terminal 300 will be described. FIG. 5 is a view showing an outer appearance of the controller.

As shown in the figure, a controller 40 is, for example, a controller dedicated to the PlayStation (registered trademark). However, other controllers may be used.

Various functions for handling the slide image (and the folder) stored in the PACS server 100 are allocated to each button (and a stick) of the controller 40.

A select button 41 is used to switch between a folder view screen (slide selection screen) to be described later and a slide view screen.

A start button 42 is used for a user of the PACS client terminal 300 to obtain an operation right of the PACS server 100 via the PACS client terminal 300. For example, the operation right is obtained when the start button is depressed, and the operation right is returned when the start button is long-pressed. This is a necessary function because the number of PACS client terminals 300 that access the single PACS server 100 is not limited to one.

A left stick 43 is used to move a pointer in an arbitrary direction. Further, the right stick 44 is used to move a viewpoint in the slide view screen.

A “circle” button 45 is used to display and determine a slide image. A “cross” button 46 is used to cancel an operation of closing a folder, a screen, or the like. A “square” button 47 is used to open and close a slide tray to be described later. A “triangle” button 48 is used to open an option menu.

Direction keys 49 are used to move a viewpoint in the slide view screen and move a focus in other screens.

An L1 button 50 is used to gradually reduce the size of a display target object. An L2 button 51 is used to continuously reduce the size of the display target object. Further, when a brother folder (neighbor folder in the same hierarchy layer) is present in a folder (and a virtual folder to be described later) stored in the storage unit 18, the L2 button 51 is also used to move to the brother folder on the left-hand side, for example.

An R1 button 52 is used to gradually increase the size of the display target object. An R2 button 53 is used to continuously increase the size of the display target object. Further, the R2 button is also used to move to the brother folder on the right-hand side, for example.

[Operation of System]

Next, operations of each server and each client in the system configured as described above will be described. In this embodiment and other embodiments, the operations of each server and each client are performed by cooperation between the CPU and software modules executed under the control of the CPU.

(Display of LIS Search Result)

FIG. 6 is a flowchart showing a flow of the operations.

As shown in the figure, the LIS client terminal 400 first accesses the LIS server 200, using patient information such as the patient name (patient number), the date and time of examination, and the disease name as the search condition and searches for the examination information (Step 61).

In response to the search request, the LIS server 200 searches for the patient information and sends a search result to the LIS client terminal 400 (Step 62).

If a slide image that matches the search condition is present as the search result, the number (unique ID) of the slide image captured in examination of the patient is identified and the identified number is sent back to the LIS client terminal 400 as the search result (Yes in Step 63).

Subsequently, the LIS client terminal 400 sends the display request of a slide data having the ID to the PACS server 100, using the ID (Step 64).

When receiving the display request, the CPU 11 of the PACS server 100 checks the correspondence between the LIS client terminal 400 that has sent the display request and the PACS client terminal 300, using the table shown in FIG. 4 (Step 65).

If the PACS client terminal 300 corresponding to the LIS client terminal 400 that has sent the display request is found (Yes in Step 65), the CPU 11 generates a virtual folder whose an access right is provided only to the corresponding PACS client terminal 300 and prepares the slide image being a target of the display request below that folder (Step 66).

FIG. 7 is a view showing an example of a folder view screen displayed on the display unit of the PACS client terminal 300 before the display request by the LIS client terminal 400.

As shown in the figure, by the PACS client terminal 300 accessing the PACS server 100, the folder dir1, the folder dir2, and the slide 01 shown in the FIG. 3 are displayed as a folder icon 72, a folder icon 73, and a folder icon 74, respectively. An upper-level folder such as the folder dir0 in FIG. 3 is accessible through an upper-level folder icon 71.

FIG. 8 is a view showing a folder configuration within the PACS server 100 in the case where the virtual folder is generated.

As shown in the figure, in addition to the substantial folders as shown in FIG. 3, a search result folder 81 is generated as the virtual folder. Under the search result folder 81, a virtual folder 82 is generated as a folder showing a first search result. Under the virtual folder 82, as a pointer to substantial slide data corresponding to the ID, a virtual file is prepared as, for example, “\LIS search result/search result 0/slide21.” The pointer is set as, for example, a short cut (symbolic link). However, a substantial slide may be copied and actually stored under the virtual folder.

Referring back to FIG. 6, the CPU 11 of the PACS server 100 sends the display request for requesting to display slide data in the virtual folder 82 to the PACS client terminal 300 (Step 67).

FIG. 9 is a view showing a screen displayed in the display unit of the PACS client terminal 300 when the PACS server 100 sends a display request to the PACS client terminal 300.

As shown in the figure, in the PACS client terminal 300, a slide image 91 being a display request target from the LIS client terminal 400 is displayed together with a map 92 showing a display position, for example. The screen is a slide view screen that displays an actual slide image.

A slide tray 93 is displayed on the left-hand side of the slide view screen, for example. The slide tray 93 serves to display all the slide images included in the virtual folder as a thumbnail list. On the slide tray 93, a marker 95 is displayed on a thumbnail of the slide being currently displayed (on the right-hand side). In FIG. 8, only one image is shown as the slide image in the virtual folder. However, FIG. 9 shows, for the sake of description, an example in which a plurality of slide images are included in the virtual folder and displayed as thumbnails on the slide tray 93.

Switching to display and hidden the slide tray 93 can be performed by a depress operation of the “square” button 47 of the controller 40 of the PACS client terminal 300 as described above.

Also when not the virtual folder but an actual folder (e.g., folder dir1 in FIG. 3) that corresponds to the search request sent from the LIS client terminal 400 is displayed by the PACS client terminal 300, a similar slide view screen and the corresponding slide tray 93 are displayed.

In this manner, if the LIS client terminal 400 sends the display request of the slide, the user of the PACS client terminal 300 does not perform any operations but the target slide is displayed in the PACS client terminal 300.

However, the LIS client terminal 400 may send a request to open not a slide but the corresponding virtual folder in the folder view screen by the PACS client terminal 300. The number of slides that match the search condition in not limited to one, and hence a plurality of slides are sometimes placed in the virtual folder or in a folder below the virtual folder. In this case, the LIS client terminal 400 may send a request to display a particular slide as described above. Alternatively, the PACS client terminal 300 may only open the virtual folder and selection of the slide may be left to the user.

FIG. 10 is a view showing an example of the folder view screen in the case where the virtual folder is generated in response to the display request. As described above, the folder view screen and the slide view screen as shown in FIG. 9 are switched by the select button 41 of the controller 40 of the PACS client terminal 300.

As shown in the figure, when the virtual folder is generated in the PACS server 100 in response to the display request sent from the LIS client terminal 400, a virtual folder icon 101 showing the virtual folder is newly displayed. When the virtual folder is opened, as shown in FIG. 9, the slide image included in the virtual folder is displayed on the slide view screen. In the case where a plurality of slides are present in the virtual folder (slides that match search condition), a list of icons of those slides may be displayed still on the folder view screen such that the user can select one slide among them.

As a request transmitted from the LIS client terminal 400 to the PACS server 100, the following three commands are conceivable including a display request of the slide data described above.

Create

This is a command that requests to display a search result. This command specifies an appropriate slide list together with an ID for uniquely defining a search. For example, this Create request is used when the user searches for a case of a certain patient or when the user searches for previous cases associated with that patient.

Delete

This is a command for specifying an ID when the Create request is performed and requesting to delete the search result. For example, this Delete request is used when the user closes the associated case and views the original case again.

Reset

This is a command for requesting to delete all the search results and returning to the initial state. For example, this Reset command is used when the user closes the case of the particular patient in order to search for a similar case of a patient different from the particular patient.

For example, those three commands are transmitted by the user operating a user interface for an LIS in the LIS client terminal 400.

In the state shown in FIG. 8, when the LIS client terminal 400 issues a Create command specifying “\ search result 1” as the ID and two of “\dir0/dir1/slide12” and “\dir0/dir2/dir3/slide30” as the slides, the folder structure is as shown in FIG. 11.

As described above, upon diagnosis, the user sometimes views previous cases or similar cases of the same patient. When the user continuously performs a new search, the PACS server 100 generates a new virtual folder 83 (“\LIS search result/search result 1””), leaving the previous virtual folder 82 (“\LIS search result/search result 0”).

When preparation of the virtual folder 83 and slides (slide 12 and slide 30 in figure) under the virtual folder 83 is completed, the PACS server 100 transmits the display request of either one of the two slides (or the virtual folder 83) to the PACS client terminal 300 corresponding to the LIS client terminal 400 that has transmitted the new Create request.

FIG. 12 is a view showing a slide view screen displayed in the display unit of the PACS client terminal 300 in the case where the PACS server 100 sends a new display request to the PACS client terminal 300.

As shown in the figure, when a display request of a new LIS search result is provided in a state where the slide tray 93 is opened, the contents of the slide tray 93 are updated from the state shown in FIG. 9 to a slide list of the new search result (slides included in the new virtual folder 83). Along with this, the slide image to be displayed is also switched to one slide image 121 in the slide tray 93. As a matter of course, also in a state where the slide tray 93 is not displayed, the switching of the slide image is performed.

FIG. 13 is a view showing an example of the folder view screen in the case where the virtual folder 83 is generated according to the new display request. As shown in the figure, an icon 102 showing the new virtual folder 83 is displayed with an icon 101 showing the previously generated virtual folder 82 being displayed.

By sequentially displaying the search results in the LIS as folders in this manner, the user can check the search result and refer to another search result by moving the folder. Therefore, the user of the PACS client terminal 300 can view also a slide searched for in the LIS client terminal 400 only by a normal folder operation.

Next, from the state shown in FIG. 11, a case where the LIS client terminal 400 requests a Delete command with respect to the search result with an ID being “\ search result 0” is assumed. In this case, as shown in FIG. 14, the PACS server 100 deletes the pointer to the virtual folder 82 (“\LIS search result/search result 0”) and the slide 21 under the virtual folder 82.

After completion of the deletion, the PACS server 100 performs notification to the corresponding PACS client terminal 300. At this time, the PACS server 100 may simply make a notification that the search result has been deleted or may make a notification to open a most recent virtual folder 83 (“\LIS search result/search result 1”) among the remaining folders after the deletion.

FIG. 15 is a view showing a display example of the folder view screen after the deletion. As shown in the figure, in comparison with the screen shown in FIG. 13, it can be seen that the icon 101 corresponding to the virtual folder 82 being a deletion target has been deleted.

When the LIS client terminal 400 sends the Reset command, the PACS server 100 that receives the Reset command deletes all the virtual folders and slides present in and below an LIS search result folder 81 and makes a notification to the corresponding PACS client. With this, the folder view screen returns to the screen shown in FIG. 7.

(Display of Search Result in PACS)

In the above description, the PACS server 100 creates the virtual folder according to the request sent from the LIS client terminal 400. However, according to a request sent from the PACS client terminal 300, a result of a search performed by the PACS server 100 itself can also be handled with a similar folder configuration.

FIG. 16 is a view showing a structure of the folder generated in the PACS server 100 based on a search request sent from the PACS client terminal 300.

As shown in the figure, the PACS server 100 is capable of specifying conditions, for example, “recently viewed slide,” “(slide with) Sticky Note,” and “imaging date” as search conditions in a slide search request sent from the PACS client terminal 300, to thereby narrow down the slides stored in the storage unit 18. Then, the PACS server 100 is capable of generating folders of a recently viewed slide folder 161, a Sticky Note folder 162, an imaging date folder 163 can be generated as a search result depending on the search conditions.

Below the recently viewed slide folder 161, several slides most recently viewed are placed.

Below the Sticky Note folder, a virtual folder is created for each color of sticky notes attached to the slides. In this example, a pink sticky note is attached to the slide 10 and a blue sticky note is attached to the slide 20. Below each of the virtual folders 164 and 165, a pointer to each slide is placed. Although a green sticky note may also otherwise be attached, a target slide is not present in this example, and hence the corresponding virtual folder is also not present.

Below the imaging date folder 163, all slides are grouped in virtual folders (folders 166 to 171) for each imaging year and month. In this case, selecting the virtual folder (search condition) in a lower hierarchy layer means performing a logical conjunction with the virtual folder (search condition) in an upper layer, and hence it corresponds to performing a search under more severe conditions. If a huge number of slides are present, virtual folders of the imaging date and time or the like may be further created.

FIG. 17 is a view showing a folder view screen corresponding to a folder configuration shown in FIG. 16. As shown in the figure, an icon 173 indicating the recently viewed slide folder 161, an icon 174 indicating the Sticky Note folder 162, and an icon 175 indicating the imaging date folder 163 are displayed together with an icon 171 indicating the folder dir0 (substantial folder) and an icon 172 indicating a virtual folder corresponding to the LIS search result (as folders in the same hierarchy layer).

The folders are configured and the icons are displayed in this manner, and hence the user can access both the search result in the LIS client terminal 400 and the search result in the PACS server 100 using the common user interface.

(Movement Between Brother Folders)

As described above, when the LIS client terminal 400 continuously provides a plurality of display requests corresponding to a plurality of search results, as shown in FIG. 11, the virtual folders 82 and 83 corresponding to the search result are generated. On the folder view screen, the icons 101 and 102 indicating them are displayed on the same screen (e.g., to be close to each other).

In this embodiment, the user of the PACS client terminal 300 can perform a direct movement between the folders (brother folders) closer to each other in the same hierarchy layer like the virtual folders 82 and 83 without moving to a folder in an upper layer, by operating the controller 40.

FIG. 18 is a view showing a state of a movement between the brother folders. When the PACS client terminal 300 sends an operation signal indicating a depress operation of the L2 button 51 or the R2 button 53 of the controller 40 to the PACS server 100, the PACS server 100 determines whether or not a brother folder of a currently displayed folder is present. If the brother folder is present, the PACS server 100 performs a movement between those brother folders.

Specifically, for example, as shown in FIG. 9, when the operation signal is received in a state where the virtual folder 82 is displayed on the slide view screen, the PACS server 100 switches the folder to the virtual folder 83 that is a brother folder of the virtual folder 82 as shown in FIG. 18.

At this time, the PACS server 100 displays a dialogue 181 indicating a movement between both folders such that the user can know from which of the folders to which of the folders the movement is performed. By this movement, the contents of the slide tray 93 are updated from the virtual folder 82 to the virtual folder 83. For example, the first slide image 121 of the virtual folder 83 after the movement is displayed.

In this manner, the user of the PACS client terminal 300 can immediately view the contents of the brother folder without returning to the LIS search result folder 81, for example, only by depressing the L2 button 51 or the R2 button 53.

As a matter of course, also when the brother folder is present not in the virtual folder but in a normal folder, a movement between the brother folders is performed by the same operation and processing.

### Conclusion

As discussed above, according to this embodiment, the PACS server 100 can generate the virtual folder including the pathological image data as the search result and display the virtual folder in the PACS client terminal 300 by dividing the LIS client terminal 400 that is accessible to the patient information and the PACS client terminal 300 that is accessible to the slide image data and at the same time associating the LIS client terminal 400 with the PACS client terminal 300. With this, the PACS server 100 enables the image data searched for using the patient information to be displayed in another PACS client terminal 300 as if the image data was the search result of that terminal without increasing the number of terminals that are accessible to the LIS server 200 in which personal information of patients is stored.

Further, the user of the PACS client terminal 300 can view the image data as the search result from the LIS by a user interface similar to a normal folder and file operation. In addition, the user can view the search result using meta-information and the search result from the LIS by the PACS server 100 in the similar user interface.

### Modified Examples

The present disclosure is not limited only to the above-mentioned embodiment and may be variously changed without departing from the gist of the present disclosure.

In the above-mentioned embodiment, as shown in FIG. 6, the LIS client terminal 400 sends the received search result to the PACS server 100 and thus the virtual folder is generated in the PACS server 100. However, the LIS search result does not need to be sent to the LIS client terminal 400 and may be sent by the LIS server 200 to the PACS server 100.

FIG. 19 is a flowchart showing a flow of an operation of a system in this case. In comparison with the flowchart shown in FIG. 6, the flowchart of FIG. 19 is different from the flowchart of FIG. 6 in that the LIS server 200 sends a display request of a slide instead of an LIS client terminal 400 in Step 195. At this time, the LIS server 200 sends also an ID of the LIS client terminal 400 that has performed the search request to the PACS server 100.

In each of the above-mentioned embodiments, the table showing the correspondence between the client terminals is stored in the PACS server 100. However, the storage location of this table is not limited thereto, and, for example, the table may be stored in the LIS server 200. In this case, the LIS server 200 may check the correspondence between the client terminals and then send the display request to the PACS server 100 together with IDs of both the client terminals.

The configurations of the slide view screen and the folder view screen shown in each figure described above are not limited to those shown in those figures, and various display configurations are conceivable.

The “pathological image data” described in the above-mentioned embodiments includes not only an image of a specimen of a cell, a tissue, or an organ of a patient that is captured by a microscope, but also an X-ray image, a magnetic resonance imaging (MRI) image, and the like.

In each of the above-mentioned embodiments, the example in which the present disclosure is realized via the network in the hospital has been shown. However, as a matter of course, the environment in which the present disclosure is realized is not limited to the hospital.

### Others

The present disclosure may also take the following configurations.

(1) An information processing apparatus, including:

a storage unit configured to store
a plurality of pathological image data items associated with patient information, and
correspondence relationship information that indicates a correspondence relationship between
   a first different information processing apparatus configured to be accessible to the patient information, and
   a second different information processing apparatus configured to be accessible to the plurality of pathological image data items and inaccessible to the patient information;

a communication unit; and

a control unit configured to be capable of
controlling the communication unit to receive, from the first different information processing apparatus, a first display request of a first pathological image data item searched for based on predetermined patient information, and
generating, based on the correspondence relationship information, a first virtual folder including the first pathological image data item, the first virtual folder being accessible by the second different information processing apparatus that corresponds to the first different information processing apparatus that sends the first display request.
   (2) The information processing apparatus according to (1), in which

the control unit is configured to control the communication unit to send an open request for requesting to open the first virtual folder to the second different information processing apparatus.

(3) The information processing apparatus according to (1) or (2), in which

the control unit is configured to control the communication unit to send an open and display request for requesting to open the first virtual folder and display a predetermined pathological image data item to the second different information processing apparatus.

(4) The information processing apparatus according to any one of (1) to (3), in which

the control unit is configured to
control, after receiving the first display request, the communication unit to receive a second display request of a second pathological image data item searched for based on predetermined patient information from the first different information processing apparatus, and
generate a second virtual folder including the second pathological image data item in the same hierarchy layer as the first virtual folder, the second virtual folder being accessible by the second different information processing apparatus.
   (5) The information processing apparatus according to (4), in which

the first virtual folder and the second virtual folder respectively include
a plurality of first pathological image data items, and
a plurality of second pathological image data items, and

the control unit is configured to
enable the second different information processing apparatus to selectively display
   a first screen in which a virtual folder is displayed, and
   a second screen in which one pathological image data item in the virtual folder is displayed together with a thumbnail list of all pathological image data items in the virtual folder, and
control the second different information processing apparatus to display, when the second display request is received in a state where the second screen is displayed in the second different information processing apparatus,
   the second pathological image data item and a second thumbnail list that correspond to the second virtual folder instead of the first pathological image data item and a first thumbnail list that correspond to the first virtual folder.
      (6) The information processing apparatus according to (4) or (5), in which

the first virtual folder and the second virtual folder respectively include
a plurality of first pathological image data items, and
a plurality of second pathological image data items, and

the control unit is configured to
enable the second different information processing apparatus to selectively display
   a first screen in which a virtual folder is displayed, and
   a second screen in which one pathological image data item in the virtual folder is displayed together with a thumbnail list of all pathological image data items in the virtual folder, and
control the second different information processing apparatus
   to display, when operation notification information for notifying of a predetermined operation input is received from the second different information processing apparatus in a state where the second screen is displayed in the second different information processing apparatus, an image for notifying of a movement from the first virtual folder to the second virtual folder, and
   to display the second pathological image data item and a second thumbnail list that correspond to the second virtual folder instead of the first pathological image data item and a first thumbnail list that correspond to the first virtual folder.
      (7) The information processing apparatus according to any one of (1) to (6), in which

the control unit is configured to
control, after receiving the first display request, the communication unit to receive a delete request of the first pathological image data item from the first different information processing apparatus,
delete the first virtual folder based on the delete request, and
control the communication unit to send notification information for informing of the deletion to the second different information processing apparatus.
   (8) The information processing apparatus according to any one of (4) to (7), in which

the control unit is configured to
control, when the first virtual folder is opened, the communication unit to receive, from the first different information processing apparatus, a delete request of the first pathological image data item,
delete the first virtual folder based on the delete request, and
control the communication unit to send an open request for requesting to open the second virtual folder to the second different information processing apparatus.
   (9) The information processing apparatus according to any one of (1) to (8), in which

the control unit is configured to
control the communication unit to receive a third display request of a third pathological image data item that matches a predetermined search condition from the second different information processing apparatus, and
generate, based on the third display request, a third virtual folder including a third pathological image data item in the same hierarchy layer as the first virtual folder.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information processing apparatus, comprising:
a storage unit configured to store
a plurality of pathological image data items associated with patient information, and
correspondence relationship information that indicates a correspondence relationship between
a first different information processing apparatus configured to be accessible to the patient information, and
a second different information processing apparatus configured to be accessible to the plurality of pathological image data items and inaccessible to the patient information;
a communication unit; and
a control unit configured to be capable of
controlling the communication unit to receive, from the first different information processing apparatus, a first display request of a first pathological image data item searched for based on predetermined patient information, and
generating, based on the correspondence relationship information, a first virtual folder including the first pathological image data item, the first virtual folder being accessible by the second different information processing apparatus that corresponds to the first different information processing apparatus that sends the first display request.

2. The information processing apparatus according to claim 1, wherein
the control unit is configured to control the communication unit to send an open request for requesting to open the first virtual folder to the second different information processing apparatus.

3. The information processing apparatus according to claim 2, wherein
the control unit is configured to control the communication unit to send an open and display request for requesting to open the first virtual folder and display a predetermined pathological image data item to the second different information processing apparatus.

4. The information processing apparatus according to claim 1, wherein
the control unit is configured to
control, after receiving the first display request, the communication unit to receive a second display request of a second pathological image data item searched for based on predetermined patient information from the first different information processing apparatus, and
generate a second virtual folder including the second pathological image data item in the same hierarchy layer as the first virtual folder, the second virtual folder being accessible by the second different information processing apparatus.

5. The information processing apparatus according to claim 4, wherein
the first virtual folder and the second virtual folder respectively include
a plurality of first pathological image data items, and
a plurality of second pathological image data items, and
the control unit is configured to
enable the second different information processing apparatus to selectively display
a first screen in which a virtual folder is displayed, and
a second screen in which one pathological image data item in the virtual folder is displayed together with a thumbnail list of all pathological image data items in the virtual folder, and
control the second different information processing apparatus to display, when the second display request is received in a state where the second screen is displayed in the second different information processing apparatus,
the second pathological image data item and a second thumbnail list that correspond to the second virtual folder instead of the first pathological image data item and a first thumbnail list that correspond to the first virtual folder.

6. The information processing apparatus according to claim 4, wherein
the first virtual folder and the second virtual folder respectively include
a plurality of first pathological image data items, and
a plurality of second pathological image data items, and
the control unit is configured to
enable the second different information processing apparatus to selectively display
a first screen in which a virtual folder is displayed, and
a second screen in which one pathological image data item in the virtual folder is displayed together with a thumbnail list of all pathological image data items in the virtual folder, and
control the second different information processing apparatus
to display, when operation notification information for notifying of a predetermined operation input is received from the second different information processing apparatus in a state where the second screen is displayed in the second different information processing apparatus, an image for notifying of a movement from the first virtual folder to the second virtual folder, and
to display the second pathological image data item and a second thumbnail list that correspond to the second virtual folder instead of the first pathological image data item and a first thumbnail list that correspond to the first virtual folder.

7. The information processing apparatus according to claim 1, wherein
the control unit is configured to
control, after receiving the first display request, the communication unit to receive a delete request of the first pathological image data item from the first different information processing apparatus,
delete the first virtual folder based on the delete request, and
control the communication unit to send notification information for informing of the deletion to the second different information processing apparatus.

8. The information processing apparatus according to claim 4, wherein
the control unit is configured to
control, when the first virtual folder is opened, the communication unit to receive, from the first different information processing apparatus, a delete request of the first pathological image data item,
delete the first virtual folder based on the delete request, and
control the communication unit to send an open request for requesting to open the second virtual folder to the second different information processing apparatus.

9. The information processing apparatus according to claim 1, wherein
the control unit is configured to
control the communication unit to receive a third display request of a third pathological image data item that matches a predetermined search condition from the second different information processing apparatus, and
generate, based on the third display request, a third virtual folder including a third pathological image data item in the same hierarchy layer as the first virtual folder.

10. An information processing method, comprising:
receiving, from a first different information processing apparatus configured to be accessible to patient information, a display request of a pathological image data item searched for based on predetermined patient information;
identifying a second different information processing apparatus configured to be accessible to the pathological image data item and inaccessible to the patient information, the second different information processing apparatus being associated with the first different information processing apparatus that sends the display request; and
generating a virtual folder including the pathological image data item, the virtual folder being accessible by the second different information processing apparatus.

11. A program that causes an information processing apparatus to execute the steps of:
receiving, from a first different information processing apparatus configured to be accessible to patient information, a display request of a pathological image data item searched for based on predetermined patient information,
identifying a second different information processing apparatus configured to be accessible to the pathological image data item and inaccessible to the patient information, the second different information processing apparatus being associated with the first different information processing apparatus that sends the display request, and
generating a virtual folder including the pathological image data item, the virtual folder being accessible by the second different information processing apparatus.
